(19) United States
(12) Patent Application Publication
(10) Pub. No.: US 2014/0063180 A1
(43) Pub. Date: Mar. 6, 2014

(54) CONNECTED FOOD SCALE SYSTEM AND METHOD

(71) Applicant: Anshuman Sharma, St. Louis Park, MN (US)

(72) Inventor: Anshuman Sharma, St. Louis Park, MN (US)

(73) Assignee: BBY SOLUTIONS, INC., Richfield, MN (US)

(21) Appl. No.: 13/605,517

(22) Filed: Sep. 6, 2012

(51) Int. Cl. G08C 19/00

(52) U.S. Cl. CPC G08C 19/00
USPC 348/36; 340/870.02

(57) ABSTRACT

A food scale system and method are presented. The connected food scale system comprises a digital food scale and a plurality of mobile devices able to connect to the scale. A plurality of food logs within the scale are linked to a plurality of user identifiers. Each mobile device may contain one of the user identifiers to uniquely identify the mobile device to the scale. When a mobile device connects to the digital food scale, the scale receives the mobile device identifier and transfers food log data for the identified user to the mobile device. A physical dock for a mobile device is fixedly-attached to the food scale. A wide-angle lens is incorporated into the dock and allows a digital camera within the mobile device to capture an image of food on a weighing surface of the scale.

### FIELD OF THE INVENTION

The present application relates to the field of digital food scales. More particularly, the described embodiments relate to a digital food scale capable of connecting to a mobile computing device. A mobile device dock attached to the food scale incorporates a wide-angle lens for capturing images of food on the scale.

### SUMMARY

One embodiment of the present invention provides a digital food scale having a user interface that allows an individual to enter a user identifier and select a food to be weighed. The digital scale may detect the food item's weight, and then access a database of nutrition information to calculate nutrition information for the food item. Nutrition information can include food energy, nutrient, vitamin, mineral, and water content of a food, as well as other types of relevant food information. Food energy is generally measured in kilocalories, (often referred to simply as “calories”) or Joules. Nutrition information may represent the source of calories by breaking down the amount of fat, protein, carbohydrate, sugar, fiber, or alcohol per given weight of food. Nutrient information is generally presented in weight by grams or milligrams. Vitamin and mineral content of a food are also generally presented in weight by grams or milligrams per weight of food.

The food scale of the preferred embodiment keeps a log of foods weighed on the scale by each individual scale user. The food log may include a record of all foods eaten by a particular user. The food log may be organized by meal, by date, by time, by food type, or by other organizing method. A food log entry may include a date and time that a food was eaten, the weight of food consumed, calorie and nutrition information, number of portions, portion size, meal type, food category, notes, recipes, etc. A food log may also include one or more images of the food consumed, and miscellaneous user inputs such as user mood. In the preferred embodiment each user has a separate food log and is able to individually track foods consumed. Individual scale users identify themselves to the digital scale with a user identification code that may be a unique user ID. In one embodiment, each user identification code may have an associated password.

The digital food scale incorporates electronics elements including a computer processor, a tangible, non-transitory memory, and programming residing in the memory and accessible by the computer processor for performing digital electronics functions. In one embodiment, the scale keeps a food log for up to 6-8 individuals. However, the number of scale users will be limited only by the amount of memory available to the digital food scale. The electronics of the digital food scale may also incorporate an electronic display, an input device such as a keypad, a power source, a physical dock for communicating with a connected device, wireless communication interface, a load sensor for sensing food weight, and an analog to digital converter to convert analog information signals from the load sensor into digital signals that can be used to perform calculations. The food scale of the preferred embodiment also includes a connector dock for connecting to a mobile device such as a mobile phone, smartphone, tablet computer, notebook computer, music player, electronic organizer, or other electronic device incorporating computing and electronic communication functions. A wireless connection interface may be used in addition to or in place of the physical connector dock.

The mobile device of the preferred embodiment has a computer processor, a tangible, non-transitory memory, and programming residing on the memory for performing computing functions. The mobile device may include a wireless communication interface, a visual display, a user input interface such as a key pad or touch screen, an internal digital camera, a physical data port, and other components. The mobile device preferably has a wireless interface to connect to both the digital food scale and a remote information network such as the Internet. The wireless interface may utilize one or more of a cellular data connection, a Wi-Fi connection, a Bluetooth connection, and other such wireless communication protocols. In one embodiment the mobile device may use a first communication protocol, such as a Wi-Fi connection, to connect to the digital food scale, and a second communication protocol, such as a GSM cellular data protocol, to connect to the Internet or other remote network. The food scale and mobile device may also be wirelessly connected to a body weight scale, which may be a device as described in U.S. patent application Ser. No. ______ filed ______, 2012, and entitled “Interactive Body Weight Scale System and Method,” the contents of which are hereby incorporated by reference.

The memory of the mobile device may contain a nutrition database similar to the nutrition database of the digital food scale. The mobile device may have a mobile application program, or “app” that allows a scale user to easily log food entries and communicate with both the scale and a data store accessible via a remote network such as the Internet. The nutrition app may provide a scale user with a user identification code, which may be a unique user ID. In one embodiment, each scale user has a mobile device that is uniquely associated with one owner. In an alternate embodiment, a single mobile device may be used by a number of different users each keeping separate food logs stored on the device. When the mobile device connects to the digital food scale, the mobile device identifies itself to the food scale by transmitting a user ID. The food scale can then match the user ID of the mobile device to a user ID within the food scale memory, allowing the user to skip the step of manually entering a user ID.

In the preferred embodiment each mobile device owner can access a personal food log in the mobile device memory. Preferably, the mobile device will have the most complete and up-to-date food entries. However, if a scale user adds a new food log entry to the memory in the food scale when the mobile device is not connected, the food log in the mobile device may not have a complete food log record. To provide the mobile device with the most complete data, the food scale synchronizes its food log data, including new food log entries, with the food log of a user's mobile device each time the mobile device is connected to the food scale. In one embodiment both the mobile device and the food scale keep a complete record of all foods consumed by a particular user. In an alternate embodiment, the digital food scale may act as a temporary storage location for food log information by saving food log entries when a user's mobile device is not connected, transferring recent food log entries to the mobile device memory when the user's mobile device is connected, and erasing the recent food log entries after the data has been uploaded to the mobile device. In this embodiment the food scale does not need a large internal memory.

The mobile device of the system may provide an image capture feature. An individual user may take a picture of the food being measured and associate the image with an entry in the user's food log. The picture may also be transmitted and stored in a remote data store via a network connection. In a preferred embodiment, the digital food scale provides an image-capture stand for a mobile device. The stand provides a wide-angle lens for improving the angle of view for a camera lens within the mobile device. The stand may have multiple points of wide-angle focus to accommodate multiple types or orientations of mobile devices.

### BRIEF DESCRIPTION OF THE DRAWINGS

FIG. 1 is a perspective view of a digital food scale.

FIG. 2 is a schematic diagram showing a user interface for a digital food scale.

FIG. 3 is a schematic diagram of a connected food scale system.

FIGS. 4a-4c show perspective views of a mobile device dock for a digital food scale.

FIG. 5 is a flow chart demonstrating a method for using a connected food scale system.

FIG. 6 is a schematic diagram of a connected food scale system with a plurality of connected mobile devices.

### DETAILED DESCRIPTION

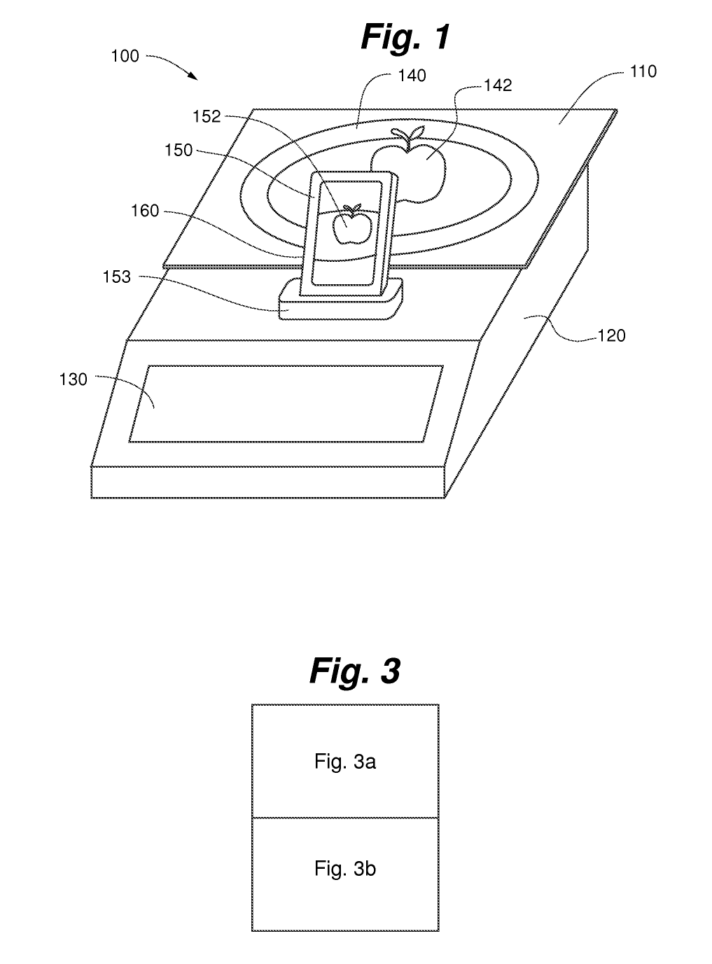

FIG. 1 shows a connected food scale system. A digital food scale 100 has a body 120, a weighing surface 110, and a display panel 130 for displaying and entering food information. A dock 153 connects a mobile device 150 to scale 100, allowing the mobile device to communicate with the scale 100. In one embodiment, the dock 153 provides a physical connection between a data communication port of the scale 100 and a data communication port of the mobile device 150. If scale 100 and mobile device 150 have wireless communication capabilities, dock 153 may serve as a connector-free dock without a physical connector. As shown in FIG. 1, a food item 142 is weighed on the food scale by placing the food on weighing surface 100. Weighing surface 100 may be washable and detachable from scale 100. A serving dish, such as plate 140, may optionally be used with scale 100. In FIG. 1, mobile device 150 is placed adjacent to an image-capture stand 160. The stand 160 provides a stable base for taking a picture of food item 142 with an internal digital camera of mobile device 150. An image 152 of food item 142 may be stored in the memory of scale 100 or mobile device 150, and may also be uploaded to a data store via a remote network such as the Internet. The stand 160 may incorporate a wide-angle lens for increasing the field of view of the digital camera.

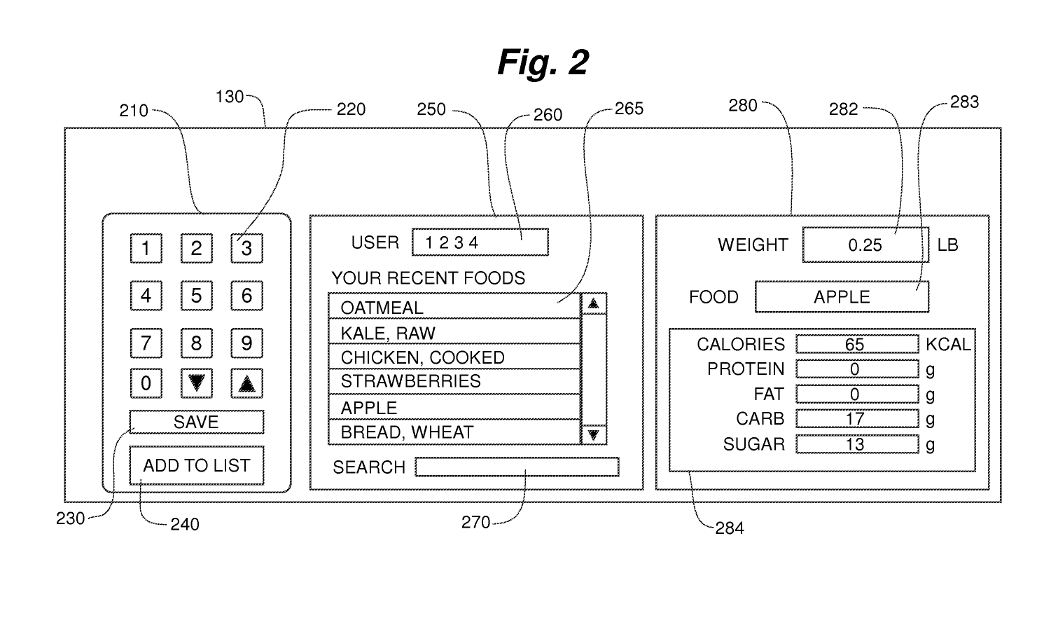

FIG. 2 shows an exemplary display and input panel 130 for scale 100. Panel 130 provides an interface for a scale user to input information into the scale memory, and to view information stored in the scale memory. FIG. 2 depicts one possible embodiment of panel 130, but the panel 130 could be implemented in many different ways. Panel 130 could be implemented using a liquid crystal display and a key pad, but could also be implemented with a keyboard, a touch screen, or other input and display methods. Various fields in panel 130 could incorporate features such as smart database look-up, auto-complete, and auto-correct. Other display and input alternatives will be evident, and the embodiment shown in FIG. 2 should not be interpreted as limiting.

Panel 130 comprises an input interface 210 having a key pad 220 having simple numeric keys. Interface 210 could also include a keyboard for entering text. Key pad 220 includes a save button 230 for instructing the digital food scale 100 to save information in internal memory. Panel 130 provides an input screen 250 showing a user ID field 260 for entering an individual scale user's identifier. The identifier may be an ID code, the user's first name and/or last name, a number, etc. Panel 130 also provides a list 265 of foods that have recently been weighed on the scale by the user identified in ID field 260. In one embodiment, each food in list 265 is identified by a food item identifier. The identifier may simply be the visible text in list 265, but could also be a code such as a unique alphanumeric code given to each food weighed on the scale. Foods could also be identified by an image or icon representing a specific food. The food item identifiers are stored in a nutrition database residing on an internal memory of the food scale. The recent foods list 265 is provided to the user in order to simplify the process of selecting a food to weigh. A search box 270 is also provided to search for foods not immediately shown in food list 265. A data output screen 280 displays the weight 282 of a food item 142 measured by scale 100. Food ID field 283 displays the type of food chosen by the user. Output fields 284 show nutrition information calculated by digital scale 100 using the internal nutrition database. The nutrition database contains calorie and nutrition information on a per-unit-weight basis. By inputting the type of food being weighed and the weight of the food, the scale 100 can calculate and display the nutrition information in output display 284. Input interface 210 includes a save button 230 that allows the user identified in user ID field 260 to save the nutrition information as a food log entry. Add to list button 240 allows the user to add the food shown in field 283 to recent foods list 265. Button 240 could also, for example, allow the user to add the food displayed in field 283 to a grocery list. The scale 100 could also add food 283 to recent food list 265 automatically.

Alternatively, foods found in an image taken by the user could be identified through image-recognition. User-created photographs could allow automatic determination of the item weighed on the scale.

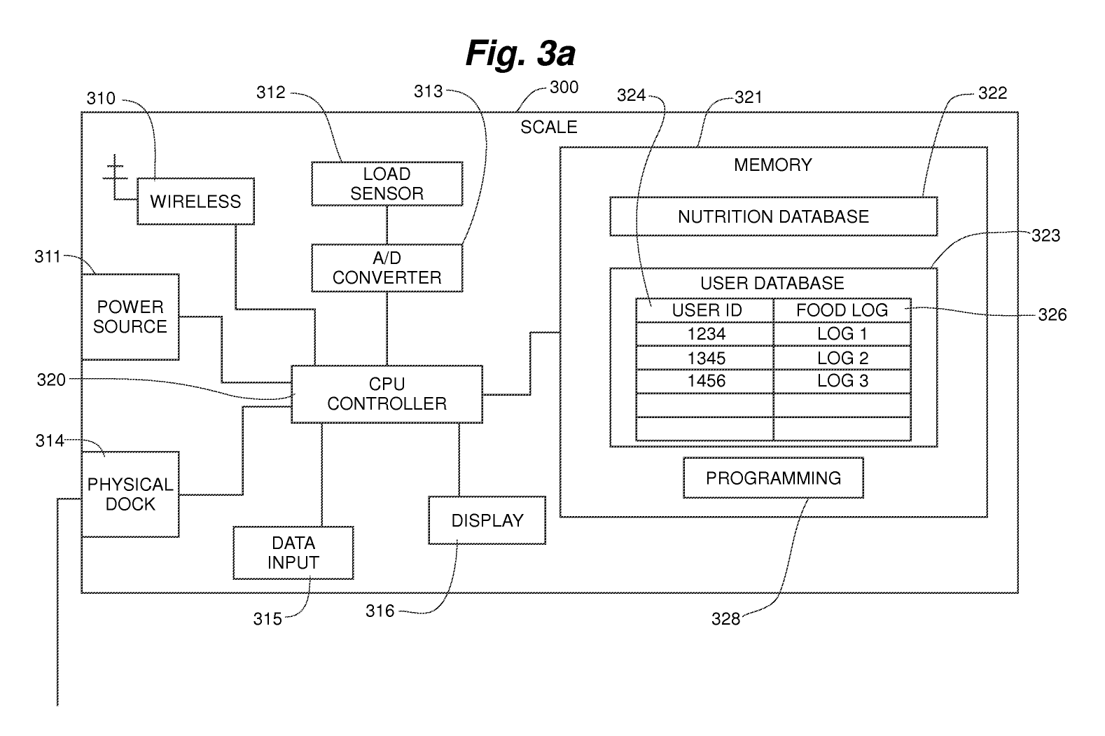

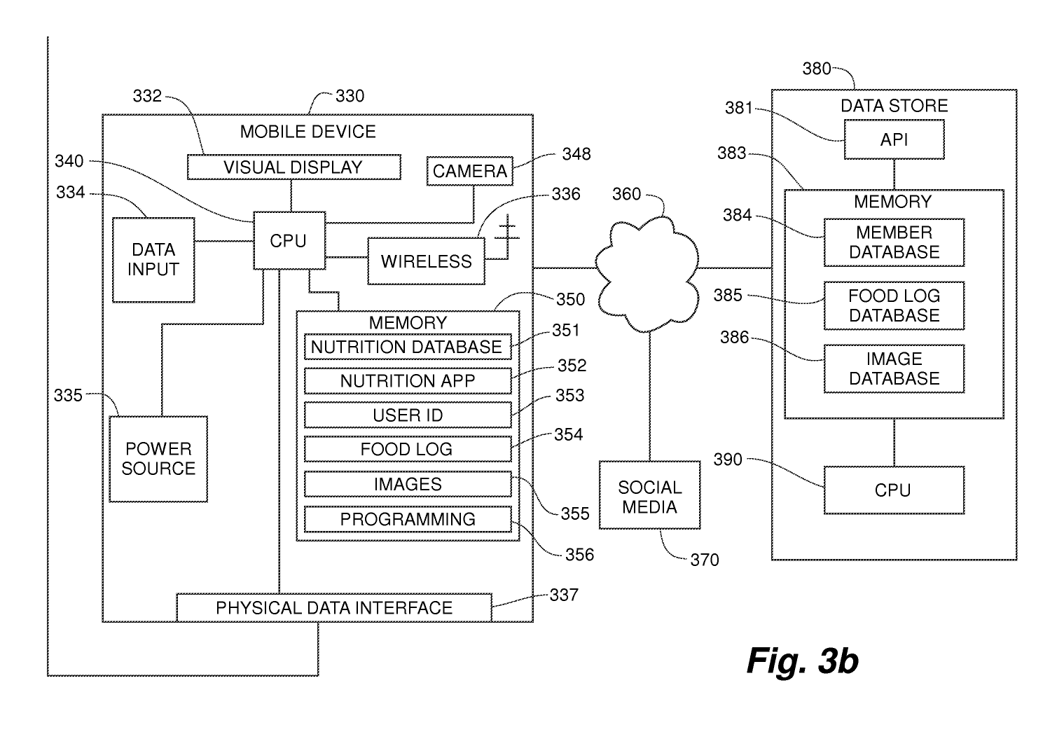

FIG. 3 shows a schematic diagram of a connected food scale system comprising a digital food scale 300 and a mobile device 330 in communication with a remote data store 380 over a network 360. A power source 311 provides power to the electronic components of the digital food scale. The power source could be a battery within scale 300, a rechargeable battery, or an electrical cord plugged into a standard wall socket. Food scale 300 measures the weight of food items using a load sensor 312, which may be implemented in one of a number of different ways. Load sensor 312 may for example utilize a spring or strain gauge. Other sensors may perform the same purpose and will be evident to one skilled in the art. U.S. Pat. No. 4,204,197 describes a digital scale that could be used in the present food scale system. Load sensor 312 is connected to an analog-to-digital converter (A/D converter) 313, which receives analog signals from load sensor 312 and converts the signals into digital signals to be sent to scale CPU 320.

A memory 321 contains a nutrition database 322. Database 322 stores nutrition information for foods to be weighed on scale 300. In the preferred embodiment, database 322 stores detailed nutrition information for hundreds of different foods that users may eat. Database 322 may be updated with new foods periodically, as necessary. Database 322 may be aggregated from one or more sources, such as government databases, food-tracking services, user-created databases, or other sources. Each of the foods in database 322 may be identified by a food item identifier, which may be an alphanumeric code. Nutrition information may include number of calories, protein content, fat content, carbohydrate content, vitamin and mineral content, water content and other numeric information for each food in the database. Although database 322 is shown in FIG. 3 as residing in memory 321, the database 322 could also be a database accessed via remote network 360. In this embodiment, the scale 300 would use wireless interface 310 to retrieve nutrition information from a remote database. Numeric information is preferably stored in the database 322 as an amount per unit weight, which allows the scale CPU 320 to easily calculate the numerical nutrient content of an item weighed on the scale. A user database 323 of food scale 300 contains food logs for multiple scale users. Each user is provided with an identifier such as a user ID 324, which may be numeric or alphanumeric. Other methods for uniquely identifying users could include biometric identification or RFID tokens, for example. Alternately, a small mobile device such as a key fob or watch having wireless capabilities could automatically send a user-identifying signal to scale 300 to wirelessly identify the user without the user having to enter any additional information. The user identifier 324 allows the scale 300 to differentiate scale users and store separate food logs 326 for each individual. Each food log 326 contains detailed information about foods that have been weighed and consumed by a user. Each entry in food logs 326 may include food weight, date and time, food type, meal type, calorie content, nutrient content, food images, metadata tags, notes, voice messages, and other such information useful for tracking eating habits. Food logs could also include user-identified mood tags entered at the time of food weighing. Programming 328 residing on memory 321 allows scale CPU 320 to control the various features of food scale 300. A user of scale 300 interacts with the scale 300 via input 315, and receives data output via display 316, as previously described in relation to FIG. 2. Input 315 could include a numeric key pad, an alphanumeric keyboard, a touch screen, voice recognition controller, hands-free controller device, or other suitable input device.

Food scale 300 connects to external mobile device 330 via wired or wireless communication. Wireless interface 310 may communicate via one or more of a Wi-Fi interface, Bluetooth interface, cellular GSM or CDMA interface, or other such wireless technology. Physical dock 314 of scale 300 may directly connect to a data interface 337 of mobile device 330. Both data interface 337 and physical dock 314 are physical connectors. Data interface 337 may comprise a female connector and physical dock 314 may utilize a compatible male connector. Wireless interface 336 of mobile device 330 may allow communication with both the scale 300 and an external data network 360. Interface 336 may utilize a Wi-Fi connection, Bluetooth connection, cellular GSM or CDMA connection, or other appropriate wireless connection type. Mobile device 330 may connect to scale 300 using a first communication protocol, and connect to network 360 using a second, different protocol.

Mobile device 330 comprises a visual display 332, a user input 334 such as a keypad or touch screen, a power source 335 that may be a battery, an integrated digital camera 348, and a memory 350 each connected to a device CPU 340. Memory 350 contains a number of different data and programming components for tracking food data. A nutrition application program 352 resides on the memory and provides a user with the ability to enter food log data and view food log entries. The nutrition app 352 may serve as a display and input device for the food scale 300 when the mobile device 330 is physically or wirelessly connected to scale 300. In this way mobile device 330 may serve to replace input 315 and visual display 316 of scale 300 when mobile device 330 is in data communication with scale 300. A nutrition database 351 may reside on the memory 350 of the mobile device 330. In an alternate embodiment (not shown) the nutrition app 352 may access a nutrition database stored remotely and accessible via a data network such as the Internet. Nutrition app 352 preferably has the ability to access the camera 348 of mobile device 330. In a preferred embodiment, digital camera 348 may capture an image of food being weighed on food scale 300, and then store the image 355 on the mobile device memory 350. In some embodiments, the image is also downloaded to the scale memory 321 and stored in the appropriate food log 326. A mobile food log 354 contains detailed information about foods that have been consumed by the owner of the mobile device 300 and foods weighed on scale 300. Each entry in mobile food log 354 may include a food identifier identifying a food weighed on scale 300, a weight of the food weighed on scale 300, date and time, food type, meal type, calorie content, nutrient content, images, metadata tags, notes, voice messages, and other such information useful for tracking eating habits. Images 355 may be linked to individual entries in mobile food log 354.

A mobile user ID 353 resides on the memory 350 of the mobile device 330. The mobile user ID 353 may identify the mobile device 330 to the food scale 300. In one embodiment mobile device 330 belongs to only one scale user. When mobile device 330 is connected to scale 300, either physically between data interface 337 and physical dock 314 of scale 300, or between wireless interface 336 of mobile device 330 and wireless interface 310 of scale 300, the mobile user ID 353 is communicated to the scale CPU 320 which accesses user database 323 in scale memory 321 and identifies a food log linked to user ID 324. In a preferred embodiment, scale 300 synchronizes food log 326 in memory 321 of scale 300 to mobile food log 354 on mobile device 330 whenever mobile device 330 is connected to scale 300. Synchronization may include sending all data in a food log for a particular user, but could also be restricted to only sending the most recent food log entries. Food logs 354 and 326 may include a list of 10 recent foods for a particular user. When mobile device 330 connects to scale 300, the list is reconciled to reflect the most recent foods weighed or entered into the food log by the user of mobile device 300.

A data store 380 accessible by mobile device 330 over a network 360 contains food log information for the user of mobile device 330. Data store 380 may belong to a third-party food and nutrition tracking service. In the preferred embodiment, an application programming interface (API) 381 allows mobile device 330 to access the data stored by the service. A tangible, non-transitory memory 383 holds information in the data store 380. A member database 384 in memory 383 holds information about users whose food logs are stored in database 385. Mobile device 330 contains identifying information that uniquely identifies the owner of mobile device 330 as a member having a food log stored in database 385. Remote food log database 385 may remotely store nutrition information contained in mobile food log 354. In one embodiment, food logs 354 and 385 are synchronized. An image database 386 of the data store 380 may hold food images taken by the mobile device 330 while connected to food scale 300, and may include other images related to food logs 385. Using a centralized images database, user-created images could be subjected to automatic food image recognition at the remote images database 386. Mobile device 330 may also be connected to a social media network 370. Social media 370 may allow mobile device 330 to post images, food log entries, nutrition information, messages, etc. on a website.

In an alternate embodiment, The digital food scale 300 may have a wireless connection to the same remote data store 380 as the mobile device 330. In this embodiment the scale 300 may access nutrition information from the remote data store 380. This would allow the scale 300 to act as a direct connection from the scale 300 to the data store 380. The scale 300 could provide spell-check and auto-complete. The scale could connect to the remote data store 380 to get nutrition information, which would make an internal food nutrition database 322 in the scale 300 unnecessary. This will allow the weight data and nutrition data to be uploaded to the same data store 380 that the mobile device 300 accesses. In this embodiment the system keeps a complete record of the user's food intake even when the mobile device 330 is not in data connection directly with the scale 300. In this embodiment the user can access a complete food log, no matter how any one particular food log entry was made.

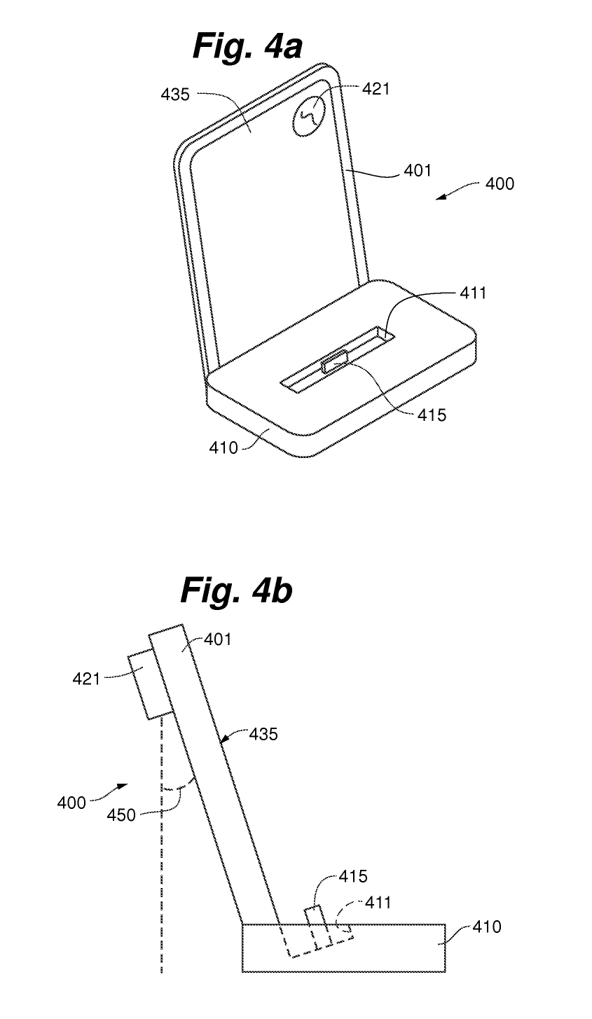

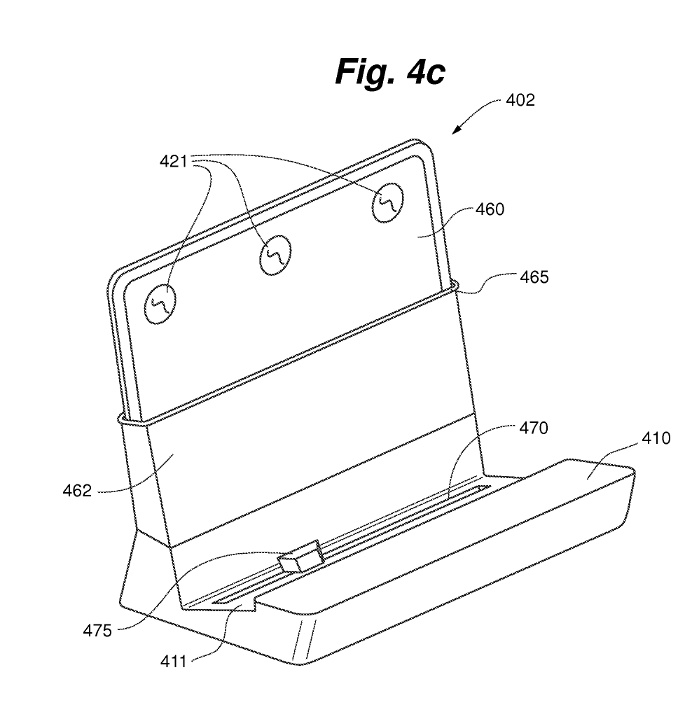

FIGS. 4a-4c show a mobile device dock for taking digital photographs on a food scale. The dock may be implemented as a docking station such as dock 153 of FIG. 1. Dock 400 could be placed in any appropriate location in relation to the weighing surface of food scale 100. In one embodiment, dock 400 is placed in a position approximately level with the weighing surface. Dock 400 could also be implemented as an elevated arm attached to the front, side, or back of scale 100. In FIG. 4a, a base 410 contains a connector 415 in a mobile device slot 411. A mobile device such as mobile device 330 of FIG. 3 has a physical data port 337 that allows device 330 to connect to a food scale 300 via connector 415 (connector 415 may be functionally equivalent to physical dock 314 of scale 300 in FIG. 3). In one embodiment, connector 415 is a male connector compatible with a 30-pin connector made by Apple Computer (Cupertino, Calif.) and described in U.S. Pat. No. 7,627,343. Connectors such as USB, mini USB, micro USB, proprietary connectors, and other connector types could also be used. In an embodiment in which mobile device 330 communicates only wirelessly with scale 300, connector 415 could be omitted.

A frame 401 of dock 400 includes a surface 435 and a wide-angle lens 421 set into a surface 435. Lens 421 may be approximately flush with surface 435, or may protrude. As shown in FIG. 3, mobile device 330 contains an internal digital camera 348. Placing mobile device 330 into slot 411 causes a lens of camera 348 to align with lens 421. The lens 421 can be a standard glass or plastic optical wide-angle lens. Lens 421 could also be a fisheye lens; in this case, image correction software could be used to correct some of the image distortion inherently created by the fisheye lens. The wide-angle lens increases the field of view of camera 348, allowing the camera 348 to take a picture of food on the surface of scale 300 at close range. In one embodiment, slot 411 and connector 415 have dimensions configured to be compatible with only one brand or model of mobile device 330. In this embodiment, the position of the lens of digital camera 348 when the mobile device 330 is connected to slot 411 will be known in advance, and the lens 421 can be located at a predetermined position within surface 435. To accommodate different models and types of mobile devices, the device dock 400 could be configured to have multiple lenses at different positions within surface 435. Frame 401 could also be constructed of a single piece of thick glass. In this embodiment the glass could be machined and polished to provide multiple curved lens “hot spots” on surface 435 that function as wide-angle lenses. This would allow multiple devices to use the same dock 400. The mobile device could be moved manually by the device user to place the device's digital camera lens over one of the machined lens hot spot areas on surface 435 to optimize the wide-angle feature. Additionally, frame 401 could be detachable and replaceable with different frames for mobile devices having lenses in different positions.

FIG. 4b shows a side perspective view of mobile device dock 400. As shown in the figure, frame 401 is not perfectly vertical, but is tilted at an angle 450. This angle 450 is optimized to direct the lens of camera 348 toward the weighing surface of scale 300. In one embodiment, the angle 450 may be between approximately 5 degrees and 12 degrees from vertical, but the angle 450 will vary based on the exact placement of dock 400. The frame 401 may be adjustable to allow the user to select the angle 450.

FIG. 4c shows an embodiment of an adaptable mobile device dock 402 having a lens plate 460 inserted in a slot 465 at the top of resting surface 462. Lens plate 460 is able to slide outside of slot 465, and is height-adjustable with respect to mobile device slot 411. Lens plate 460 may have one or more lenses 421 at different points along lens plate 460. Lens plate 460 may be removable and replaceable with other lens plates 460 having one or more lenses 421 in different positions. This allows device dock 402 to be adaptable to many different types and models of mobile devices. A connector 475 placed in a recessed slot 470 in base 410 further increases the adaptability of dock 402. Connector 475 is able to slide lengthwise along recessed slot 470, allowing the connector 475 to be moved to optimally align a digital camera lens 348 with a lens 421 when mobile device data interface 337 is connected to connector 475. Connector 475 may also be removable, replaceable, and retractable.

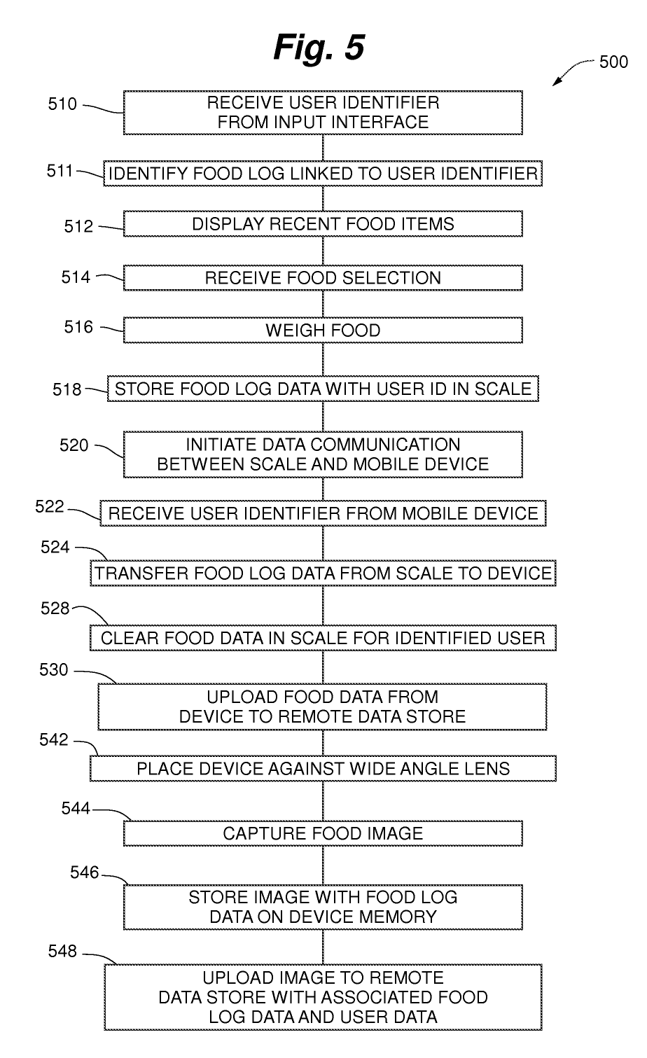

FIG. 5 shows a flow chart describing a method 500 performed by a connected food scale such as the food scale described in connection with FIG. 3. Although the method 500 is presented in FIG. 5 as a series of sequential steps, the steps may be performed in any order, and in any combination; it would be possible to implement variations that exclude steps or that include additional steps. In step 510, a user identifier 324 is received at the scale 300. The identifier may be received via the input interface 315. The user identifier 324 may be a numeric or alphanumeric user ID, but could also be a biometric identifier, voice recognition, or other identifier. The user ID 324 distinguishes a particular scale user from other users of the same scale 300. In step 511, a particular unique food log 326 linked to user ID 324 is identified. Food log 326 for user ID 324 will then be edited to add new information from the food scale 300. In step 512, information from food log 326 is used to display food items that have recently been weighed on the scale by the user identified by user ID 324. For example, the 10 most recent foods may be displayed. In step 514, a food selection is received by scale 300. The food selected may be identified by a food identifier in the nutrition database 322, such as a numeric or alphanumeric code uniquely associated with a single food having a particular nutrient content. Alternately, the user can select one of the food items from the displayed 10 most recent foods list. In step 516, the food scale weighs the selected food, and nutrition information is calculated from the nutrition database. Nutrient information may include number of calories, protein, carbohydrate, fat, vitamins, minerals, and other nutrition information. In step 518, information is added to the food log 326 and stored in memory 321 of scale 300. The information may include the food identifier, food weight, calculated nutrition information, date and time, food type, meal type, metadata tags, and other such information relevant to the weighed food. Steps 510-518 may be performed at the food scale 300 with or without the use of a mobile device.

In step 520 of method 500, a mobile device 330 is connected to scale 300. Data communication is initiated between the scale 300 and mobile device 330 either through a physical connection between data interface 337 and physical dock 314, or wirelessly between wireless interface 336 of mobile device 330 and wireless interface 310 of scale 300. Connecting mobile device 330 to scale 300 may automatically launch the nutrition app 352 on mobile device 330. In step 522, scale 300 receives a mobile user ID 353 from the mobile device 330. Mobile user ID 353 identifies mobile device 330 as corresponding to a user ID 324 on scale 300. Mobile user ID 353 may correspond exactly to a numeric or alphanumeric code of user ID 324, however the mobile user ID 353 may be different from user ID 324, as long as scale 300 is able to identify that the correct food log 326 linked to user ID 324 should be synchronized with mobile device 330. In step 524, mobile food log 354 of mobile device 330 is updated or synchronized with information from food log 326 as food log data is transferred from scale 300 to mobile device 330. The entire food log 326 may be transferred to mobile device 330. In an alternate embodiment, only the most recent food log data may be transferred through a synchronization process. The transferred data is stored in the internal memory 350 of mobile device 330 as mobile food log 354. In one embodiment, mobile food log 354 may be an exact duplicate of food log 326 in scale 300. In an alternate embodiment, additional food log data may be added to mobile food log 354 via data input interface 334 of mobile device 330. Preferably, all data stored in food log 326 is transferred to mobile food log 354.

In optional step 528, food log data in food log 326 may be cleared from scale memory 321. This would allow scale 300 to have a smaller internal memory than if scale 300 kept all data in food log 326 in memory 321 indefinitely. Only the food log 326 linked to a particular user ID 324 is cleared in this step, and only after all information in food log 326 is transferred to mobile food log 354.

After food log information has been transferred to mobile device 330, the mobile food log 354 may be transferred via a network 360 to a remote data store 380 to be synchronized with a remote food log in a food log database 385 in step 530. The data store 380 may be associated with a third-party food and nutrition tracking service that may provide an API 381 for reading and writing data. Alternately, information from mobile food log 354 may be posted to a social media site 370.

An image 355 may be added to food log 354 and uploaded to image database 386. In step 542 of method 500, the mobile device 330 is positioned to align the lens of digital camera 348 with a wide-angle lens fixed to the scale 300. In other embodiments, the digital camera 348 would be automatically positioned when the mobile device 330 is positioned in a dock 314 of the scale 300 in order to initiate data communications in step 520. In step 544, a food image is captured. In step 546, the image is stored as an image 355 on memory 350. The image 355 is then linked to food log 354. In step 548, the image 355 is uploaded to remote data store 380 and stored in images database 386.

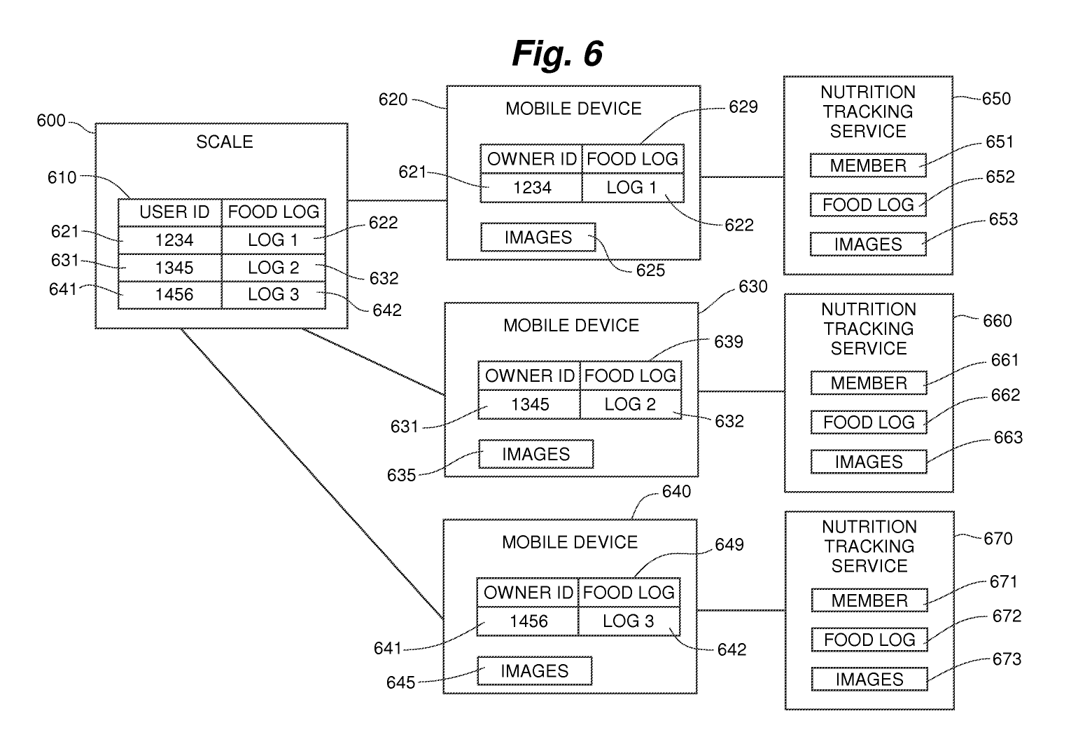

FIG. 6 shows a connected food scale system for a plurality of connected mobile devices. A food scale 600 contains a user database 610 having food log records 622, 632, and 642 linked to a plurality of scale users 621, 631, and 641. A plurality of mobile devices 620, 630, and 640 contain internal user information 629, 639, and 649 linking a food log 622, 632, and 642 with the mobile device owner identified by user IDs 621, 631, 641. Each mobile device 620, 630, 640 may uniquely identify itself to scale 600 with its user ID 621, 631, 641. The system shown in FIG. 6 may utilize the method described in FIG. 5. Specifically, in step 520 of FIG. 5, a mobile device such as mobile device 620 connects to scale 600, through either wired or wireless data communication. In step 522, the scale 600 receives a user identifier 621 from mobile device 620. The scale 600 then identifies that food log 622 should be transferred and synchronized with mobile device 620 in step 524. In step 530, the mobile device 620 uploads information from food log 622 to a data store for a remote nutrition tracking service 650. Images 625 captured using an internal digital camera of mobile device 620 may also be uploaded to service 650. The scale 600 interacts with mobile devices 630, 640 in a similar manner, identifying each mobile device based on a user ID 631, 641 received by scale 600. Mobile device 630 may also be associated with a nutrition tracking service 660, and mobile device 640 may be associated with a nutrition tracking service 670. The scale 600 in the system of FIG. 6 may be “agnostic,” in that food log data in food logs 622, 632, 642 may be compatible with many different nutrition tracking services 650, 660, 670.

The many features and advantages of the invention are apparent from the above description. Numerous modifications and variations will readily occur to those skilled in the art. For example, the nutrition app on the mobile device could serve as the exclusive user interface for the food scale. In this embodiment it would be possible for the digital food scale to be constructed without any user interface. Since such modifications are possible, the invention is not to be limited to the exact construction and operation illustrated and described. Rather, the present invention should be limited only by the following claims.

What is claimed is:

1. A food tracking system comprising:
a) a digital scale having
i) a scale data interface for data-coupling with an external mobile electronic device,
ii) a plurality of unique food logs stored in a physical, non-transitory electronic scale memory, each food log containing food log entries captured by the digital scale, each food log being identified by one of a plurality of food log identifiers stored in the scale memory, and
iii) scale programming residing on the scale memory to send a selected food log entry to the external mobile device through the scale data interface in response to receiving a selected food log identifier from the external mobile device;
b) a first mobile device having
i) a first device data interface for data-coupling with the digital scale,
ii) a first food log stored in a physical, non-transitory electronic memory of the first mobile device,
iii) a first food log identifier stored in the memory of the first device, and
iv) first device programming residing in the memory of the first mobile device to cause the first mobile device to send the first food log identifier to the digital scale through the first device data interface, to receive a first food log entry from the digital scale, and to store the received first food log entry in the memory of the first mobile device; and
c) a second mobile device having
i) a second device data interface for data-coupling with the digital scale,
ii) a second food log stored in a physical, non-transitory electronic memory of the second device,
iii) a second food log identifier stored in the memory of the second device, and
iv) second device programming residing in the memory of the second device to cause the second device to send the second food log identifier to the digital scale through the second device data interface, to receive a second food log entry from the digital scale, and to store the received second food log entry in the memory of the second device.

2. The system of claim 1, wherein the first and second mobile devices each contain only one food log and only one food log identifier, and the first food log and first food log identifier are different from the second food log and second food log identifier.

3. The system of claim 1, wherein the first and second food logs contain data corresponding to food item identifiers and food weights for a plurality of foods.

4. The system of claim 3, wherein the first and second food logs contain data corresponding to at least one of weight, date, time, meal, calorie, portion, nutrient, mineral, and vitamin information for foods weighed on the digital scale.

5. The system of claim 1, wherein the digital scale further comprises a wide angle lens mounted on the digital scale, and the first food log contains an image captured by a digital camera within the first mobile device using the wide angle lens on the digital scale.

6. The system of claim 1, further comprising:
d) a first remote data store accessible via a data network, the first remote data store having a first database stored on a first data store memory;
e) a second remote data store accessible via the data network, the second remote data store having a second database stored on a second data store memory;
wherein electronically receiving the first food log entry by the first mobile device is a signal for the first food log entry to be sent to the first remote data store to be stored in the first database, and receiving the second food log entry by the second mobile device is a signal for the second food log entry to be sent to the second remote data store to be stored in the second database.

7. A method for operating a digital food scale having a physical, non-transient electronic scale memory and a plurality of food logs linked to a plurality of user-identifying codes stored on the scale memory, the method comprising:
a) receiving, by the food scale, a first user-identifying code;
b) receiving, by the food scale, a selection of a food item to be weighed on the scale, the selection being made from a database of a plurality of foods;
c) weighing the food item on the food scale;
d) storing, in the scale memory, a weight of the food item in a first food log linked to the first user-identifying code;
e) connecting to a mobile electronic device via a data communication connection;
f) receiving the first user-identifying code from the mobile device;
g) identifying the first food log based on the first user-identifying code; and
h) transmitting the stored weight to the mobile device via the data communication connection.

8. The method of claim 7, further comprising:
i) calculating nutrient values for the selected food item based on the weight of the food item;
j) storing the nutrient values in the first food log in the scale memory; and
k) transmitting the nutrient values from the scale to the mobile device via the data communication connection.

9. The method of claim 8, further comprising:
l) triggering the mobile device to transmit the stored weight and the nutrient values to a remote database to be stored in a remote food log.

10. The method of claim 8, further comprising:
l) triggering the mobile device to store the weight of the food item and the nutrient values on a physical electronic memory of the mobile device.

11. The method of claim 7, wherein the data communication connection is a wireless data connection.

12. A food-tracking apparatus comprising:
a) a digital food scale, the scale having a weighing surface and a processor connected to a tangible, non-transitory scale memory;
b) a mobile device dock fixedly-attached to the scale;
c) a wide-angle lens fixedly-attached to the mobile device dock, the wide-angle lens positioned to align with a digital camera lens for a digital camera within a mobile device when the mobile device is connected to the mobile device dock;
d) a data communication interface within the scale for data communication with the mobile device; and
e) programming within the scale, the programming configured to
i) determine a weight of a food item on the weighing surface, and
ii) transmit the determined weight from the scale to the mobile device via the data communication interface.

13. The apparatus of claim 12, wherein the programming within the scale is further configured to associate the food item with a food image, the food image being captured by the mobile device when the mobile device is connected to the mobile device dock.

14. The apparatus of claim 12, wherein the data communication interface is a wireless interface.

15. The apparatus of claim 12, wherein the mobile device dock and the wide-angle lens are oriented to point the digital camera lens toward the weighing surface when the mobile device is connected to the mobile device dock.

16. The apparatus of claim 12, wherein the data communication interface comprises a male connector located at a base of the mobile device dock.

17. The apparatus of claim 16, wherein the wide-angle lens is positioned in the mobile device dock to align with a first digital camera lens for a first mobile device having a data communication interface comprising a female connector compatible with the male connector.

18. The apparatus of claim 12, further comprising:
f) a connector slot located at a base of the mobile device dock; and
g) a dock connector located within the connector slot, the dock connector being movable along the connector slot between a first position a first distance from the wide-angle lens, and a second position a second distance from the wide-angle lens.

19. An apparatus comprising:
a) a digital food scale, the scale having a weighing surface;
b) a mobile device dock fixedly-attached to the scale; and
c) a wide-angle lens fixedly-attached to the mobile device dock, the wide-angle lens being oriented toward the weighing surface.

20. The apparatus of claim 19, wherein the mobile device dock comprises a connector-free dock.
